(19) United States
(12) Patent Application Publication
(10) Pub. No.: US 2017/0029646 A1
(43) Pub. Date: Feb. 2, 2017

(54) HIGH-DISPERSION CARBON NANOTUBE COMPOSITE CONDUCTIVE INK

(71) Applicants: BEIJING AGLAIA TECHNOLOGY DEVELOPMENT CO.,LTD., Beijing (CN); GUANGDONG AGLAIA OPTOELECTRONIC MATERIALS CO., LTD., Foshan City, Guangdong (CN)

(72) Inventors: Haiyan HAO, Foshan (CN); Xiliang CAO, Foshan (CN); Lei DAI, Beijing (CN); Lifei CAI, Beijing (CN)

(73) Assignees: BEIJING AGLAIA TECHNOLOGY DEVELOPMENT CO.,LTD., Beijing (CN); GUANGDONG AGLAIA OPTOELECTRONIC MATERIALS CO., LTD., Foshan, Guangdong (CN)

(21) Appl. No.: 15/106,749

(22) PCT Filed: Nov. 28, 2014
(86) PCT No.: PCT/CN2014/092466

§ 371 Date: Jun. 20, 2016

(30) Foreign Application Priority Data
Dec. 23, 2013 (CN) 201310716717.1

(51) Int. Cl. C09D 11/52; H01B 1/04

(52) U.S. Cl. CPC C09D 11/52; H01B 1/04; C08K 9/00

(57) ABSTRACT

A high-dispersion carbon nanotube composite conductive ink, consisting of modified carbon nanotubes, conductive polymeric material, and solvent; said modified carbon nanotubes being obtained from conventional carbon nanotubes that have been irradiated on a UV bench and then oxidized by a strong acid. Carbon nanotubes obtained via this process do not require, when preparing conductive composite ink, the addition of a surfactant to increase the dispersibility of the ink, such that the conductive layer obtained therefrom has good conductive properties, optical transmittance within the visible light range, and flexibility. The conductive properties of this flexible carbon nanotube polymeric transparent conductive film are world class, and the invention has good prospects for application.

### TECHNICAL FIELD

The present invention relates to a conductive ink with carbon nanotubes, in particular, to a high-dispersion carbon nanotube composite conductive ink.

### BACKGROUND ART

Transparent electrodes are indispensable parts for the display devices and photovoltaic devices such as LCD panels, OLED panels, touch screens, electronic papers and solar cells, etc. Indium tin oxide (ITO) exhibits an excellent light transmittance and electrical conductivity when forming ITO films on a glass substrate, thus, it plays a dominant position in the commercial applications of transparent electrodes. However, with the technological development and diversified applications of transparent electrodes, the transparent electrode must meet the following requirements: low sheet resistance, excellent transmittance and flexibility in the visible range to achieve a large area of coating into films and other simple processes. But, due to the factors of non-bending, scare natural resources, and high cost, the wide applications of ITO transparent conductive films are restricted in the flexible electronics industry in the future. Therefore, it is an urgent, key technical issue to develop new flexible transparent electrode materials to replace ITO electrode in the electronic display and photovoltaic industries. At present, the flexible transparent conductive films are developing towards high quality, high efficiency, low cost and environmental protection. Among new types of flexible electrode materials, carbon nanotube materials, due to high electron mobility and low resistivity, have been identified as an alternative of ITO transparent electrodes by the scientific research and industry fields.

Carbon nanotube is a typical, hollow layered carbon material. The tube body of carbon nanotube is composed of hexagonal graphite carbon ring structural units. It is a kind of one-dimensional quantum material with special structure (nanometer-scale radial dimension, and nanometer-scale axial dimension). Its tube wall is composed by several to dozens of coaxial round tubes. A fixed distance is maintained between layers, about 0.34 nm and the diameter is generally 2˜20 nm. P electrons of carbon atom of a carbon nanotube form a wide range of delocalized π bond, thus, the conjugate effect is remarkable. Since the structure of carbon nanotube is the same as the lamellar structure of graphite, it has excellent electrical properties. However, since a strong van der Waals force (˜500 eV/μm) and a large slenderness ratio exist between the single-walled carbon nanotubes, it is easy to form a large bundle, difficult to disperse, greatly restricting its excellent performance and practical application development. Usually the dispersion of carbon nanotube in the solvent requires various surfactants. But the formed carbon nanotube conductive films have a decreased electrical property due to non-electrical conductivity of the surfactants.

### SUMMARY OF THE INVENTION

In order to overcome the above drawbacks, the present invention provides a high-dispersion carbon nanotube composite conductive ink, without additional dispersing aids. By using the surfactant-free carbon nanotube dispersion and conductive polymer as raw materials, and through the solvent blending process (combination of ultrasound dispersion, mechanical stirring, cells pulverization, etc.), it can achieve uniform dispersion of the carbon nanotube with the conductive polymer solution, thus, the ink prepared has good stability and re-dispersibility.

A high-dispersion carbon nanotube composite conductive ink, comprising the following components (with the weight percentages):

| | |
|---|---|
| 1. Modified carbon nanotube | 0.03-1%, |
| 2. The conductive polymeric material | 0.2%-5% |
| 3. Conductive polymer cosolvent | 0.2%-1% |
| 4. Solvent | 94%-98% |

The modified carbon nanotube is prepared by the following method: (1) disperse carbon nanotubes in a low-boiling alcohol or an aqueous solution by the ultrasonic wave or cells crusher, and then place the dispersion liquid in a UV machine for irradiation 30-60 min, centrifuge; (2) have an oxidation reaction of carbon nanotubes washed by UV machine with oxidizing strong acid solution, and centrifuge; (3) After ultrasonic dispersion of carbon nanotubes washed by strong acid through low-boiling alcohol solvent or water, the high-dispersion modified carbon nanotubes are obtained.

Repeat the step (1) and/or step (2) for one or two times.

The low-boiling alcohol is ethanol or methanol.

The strong oxidizing acid is trifluoroacetic acid, nitric acid, concentrated sulfuric acid, or nitric acid or concentrated sulfuric acid added with peroxide.

The peroxide is ammonium peroxide or hydrogen peroxide.

The carbon nanotube is a single-walled carbon nanotube, double-walled carbon nanotube, multi-walled carbon nanotube.

The conductive polymer is one of polyaniline, 3,4-ethylene dioxythiophene, polyacetylene or polypyrrole or the combinations thereof.

The co-solvent for the conductive polymer is polystyrene sulfonate, camphorsulfonic acid or naphthalene sulfonic acid.

The solvent is one of water, ethanol, methanol or the combinations thereof.

### Description of Preparation Method of the Composite Conductive Ink

1. The preparation of carbon nanotube dispersion:

Firstly, the carbon nanotube powder is dispersed in a low-boiling alcohol or an aqueous solution or dispersed by ultrasonic wave or cell crusher, and dispersion liquid is irradiated in the UV machine for some time, centrifuged, to get carbon nanotube powder; then the carbon nanotube washed with UV machine by using strong acid to control the reaction conditions. And finally, after the carbon nanotube washed by strong acid is centrifuged and separated for many times and washed repeatedly by ultrasonic wave, the uniform single-walled carbon nanotube dispersion can be obtained. The process steps in this method can be repeated and adjusted many times, especially in strong acid cleaning process, different strong acids have different effect on the amorphous carbons, and the solubility and cleanliness of resulting carbon nanotubes are greatly different. The recovery rate of carbon nanotubes is around 80%.

2. Strong acids used in the invention include trifluoroacetic acid (TFA), nitric acid, concentrated sulfuric acid, hydrogen peroxide, etc., and easily decomposed acid of inorganic salts will not be residual on the arbon nanotube surface. Appropriate solvents include low boiling alcohols such as methanol, ethanol; water; N, N-dimethylformamide (DMF), etc.

3. The surfactant-free carbon nanotube dispersion is mixed with conductive high-polymer solution; and through mechanical stirring combined with ultrasonic dispersion, or mechanical stirring combined with cell crushing, the blended solution forms a stable, uniform carbon nanotube polymer dispersion system, and finally it is concentrated to an appropriate concentration.

After modification, the carbon nanotubes in the formulation have a greatly increased dispersibility in common solvents. Combined with a conductive polymeric material, it can be made into composite conductive ink; without additional external surfactant for solubilization, it can enhance the conductive properties of the conductive ink. For the high-dispersion carbon nanotube composite conductive ink, fine electrode patterns can be produced by spin coating and laser ablation techniques, or the electrode patterns of fine structures can be produced by ink jet printing technique under room temperature.

The composite conductive ink can be applied to the extremely transparent electrode materials of flexible OLED display devices, solar cells, liquid crystal displays, touch screen panels, which have good compatibility and high adhesion with transparent polymer substrates, and can achieve the flexibility of the transparent conductive films, in addition, it can meet the service life requirement of transparent, flexible electrodes.

### BRIEF DESCRIPTION OF THE DRAWINGS

FIG. 1 is a surface topography AFM photograph of substrate PET film surface

FIG. 2 is a surface topography AFM photograph of film formed by a composite conductive ink on the PET surface in the invention

FIG. 3 is a SEM image of modified CNT film, wherein A is a multi-walled carbon nanotube (MWCNT), B is a single-walled carbon nanotube (SWCNT).

### DETAILED DESCRIPTIONS OF THE PREFERRED EMBODIMENTS

This invention is further described in details in combination with embodiments.

The poly-3,4-ethylene dioxythiophene:polystyrene sulfonate aqueous solution (PEDOT:PSS) in the invention is a purchased product; the PEDOT content is 1.8%, and the content of sodium polystyrene sulfonate is 0.5%. It can be prepared according to the following step: dissolve PEDOT in water, and add 25% aqueous solution of PSS for solubilization due to poor solubility.

Embodiment 1

| | |
|---|---|
| Modified single-walled carbon nanotube solution in methanol | 10 ml |
| Conductive polymer aqueous solution 1.8% PEDOT: PSS solution | 20 ml |
| Concentrated to a volume of 15 ml | |

Preparation method: Disperse 0.05 g of single-walled carbon nanotube (SWCNT) in 20 ml of methanol under ultrasound condition for 20 min to form SWNT suspension. Place this SWCNT suspension in a UV washing machine for treating 40 min, to get SWCNT powder; take 20 ml of deionized water to a single-necked flask, then add 10 ml of concentrated HNO₃ (68 wt %) and 5 wt % ammonium persulfate (APS) aqueous solution, mix well, add the purified SWCNT powder, and reflux to react 5 h at 120° C. while magnetic stirring, then repeatedly centrifuge and flush 3 times using deionized water (7000 rpm, 10 min), and then perform ultrasonic dispersion of the resulting single-walled carbon nanotube for 20 min, centrifuge, repeat twice, to finally get 10 ml of SWCNT methanol dispersion liquid.

Mix 20 ml of 1.8% PEDOT:PSS aqueous solution and 10 ml of SWCNT methanol dispersion liquid evenly, and concentrate to 15 ml (weighing about 15 g), to form uniformly dispersed SWCNT/PEDOT:PSS ink solution.

Embodiment 2

| | |
|---|---|
| Modified multi-walled carbon nanotube (MWCNT) | 20 ml |
| ethanol solution | |
| 1.8% PEDOT: PSS solution | 20 ml |

Preparation Method:

Disperse 0.05 g of MWCNT in 20 ml of methanol under ultrasound condition for 20 min to form MWCNT suspension. Place this MWCNT suspension in a UV washing machine for treating 40 min, to get MWCNT powder; perform ultrasonic cleaning of the resulting MWCNT powder in 20 ml of DMF and TFA mixture (9:1/Vol) for 30-60 min, centrifuge to separate at a speed of 7000 rpm, then repeat ultrasonic cleaning 5 times, finally perform ultrasonic dispersion 20 min in ethanol, then centrifuge, repeat twice, finally to get 20 ml of MWCNT ethanol dispersion liquid.

Mix 20 ml of 1.8% PEDOT:PSS aqueous solution and 10 ml of MWCNT ethanol dispersion liquid evenly, and concentrate to 15 ml (weighing about 15 g), to form uniformly dispersed MWCNT/PEDOT:PSS ink solution.

Embodiment 3

| | |
|---|---|
| Modified SWCNT methanol | 10 ml |
| 1.8% PEDOT: PSS solution | 20 ml |

Preparation Method:

Disperse 0.05 g of single-walled carbon nanotube (SWCNT) in 20 ml of methanol under ultrasound condition for 20 min to form SWNT suspension. Place this SWCNT suspension in a UV washing machine for treating 40 min, to get SWCNT powder; take 20 ml concentrated sulfuric acid in a single-necked flask, add the purified single-walled SWNT powder under magnetic stirring, and swell 12 h at room temperature. After the mixed SWNT concentrated sulfuric acid solution is diluted in 10:1 water, centrifuge to separate, and repeat four times, to get the single-walled SWNT powder. Place this powder in a single-necked flask, add 20 ml deionized water, and then add 10 ml of concentrated HNO₃ (68 wt %) and 10 ml of H₂O₂, and reflux to react 5 h at 85° C. while magnetic stirring, then repeatedly centrifuge and flush 3 times using deionized water (7000 rpm, 10 min), and then perform methanol ultrasonic dispersion of the resulting single-walled carbon nanotube for 20 min, centrifuge, repeat twice, to finally get 10 ml of SWCNT methanol dispersion liquid.

Mix 20 ml of 1.8% PEDOT:PSS aqueous solution and 10 ml of SWCNT methanol dispersion liquid evenly, and concentrate to 15 ml (weighing about 15 g), to form uniformly dispersed SWCNT/PEDOT:PSS ink solution.

Preparation of Carbon Nanotube Polymer Conductive Film

For the high-dispersion carbon nanotube composite conductive ink provided in the invention, fine electrode patterns can be produced by spin coating and laser ablation techniques, or the electrode patterns of fine structures can be produced by ink jet printing technique under room temperature.

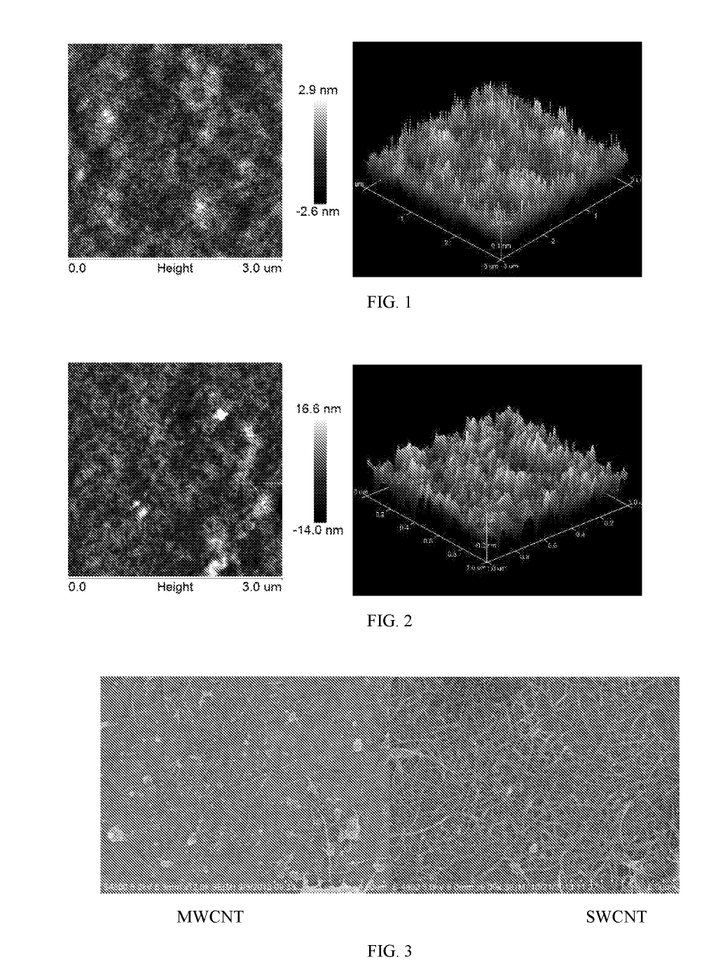

The composite conductive ink in the invention has better process operability. The ink-jet printing technique, spin-coating technique and photolithography technique can be adopted to prepare f carbon nanotube conductive polymer film on the surfaces of glass, transparent crystal, transparent ceramics and polymer films, etc. Its film surface morphology is shown in FIGS. 1, 2, 3.

The carbon nanotubes have excellent dispersion in the carbon nanotube dispersion, forming single beam mesh dispersion. After coating of carbon nanotube polymer ink on the PET film surface, the carbon nanotube film formed is a uniform carbon nano-polymer chain, and its surface roughness is only 2.79 nm.

Performance Testing of Conductive Carbon Nano-Film Layer:

TABLE 1
Carbon nanotube polymer conductive film

| | Sheet | | | Rq |
|---|---|---|---|---|
| | resistance | Transmittance/ | Ra mean | RMS |
| Sampe | Ω/□ | 550 nm | roughness | roughness |
| PET film | ∞ | 90% | 0.65 nm | 1.65 nm |
| Conductive | 90 | 80% | 3.94 nm | 2.97 nm |
| carbon nano-film | | | | |

The carbon nano-polymer transparent conductive film formed by ink has excellent electrical conductivity and optical transmittance and flexibility within the visible light range. The electrical conductivity of this transparent flexible carbon nano-polymer conductive film can be adjusted in the range of (100Ω/□-1MΩ/□). The preparation cost of this carbon nanotube polymer conductive ink is low, and the product is energy-saving and environmentally friendly, having no toxic and side effects, and its process is simple. Compared with the performance of conductive nano-carbon polymer electrode materials at home and abroad, the flexible nano-carbon electrode materials prepared in the invention possess leading performance, as shown in Table 2.

TABLE 2
Comparison of photoelectric properties between the domestic and foreign
conductive carbon nano-films and carbon nano-films in the invention

| Sample | Sheet resistance Ω/□ | Transmittance/550 nm |
|---|---|---|
| Conductive carbon | 90 | 80% |
| nano-film | | |
| Best in the industry | 152 | 83% |

The carbon nanotube polymer flexible electrode ink and the prepared transparent flexible conductive films in the invention will exhibit good application prospect in the flexible transparent electrodes necessary for touch screens, solar cells and OLED and other display devices.

What is claimed is:

1. A high-dispersion carbon nanotube composite conductive ink, comprising the following components (with the weight percentages):

| | |
|---|---|
| 1) Modified carbon nanotube | 0.03-1%, |
| 2) The conductive polymeric material | 0.2%-5% |
| 3) Conductive polymer cosolvent | 0.2%-1% |
| 4) Solvent | 94%-98% |

The modified carbon nanotube is prepared by the following method: (1) disperse carbon nanotubes in a low-boiling alcohol or an aqueous solution by the ultrasonic wave or cells crusher, and then place the dispersion liquid in a UV machine for irradiation 30-60 min, centrifuge; (2) have an oxidation reaction of carbon nanotubes washed by UV machine with oxidizing strong acid solution, and centrifuge; (3) After ultrasonic dispersion of carbon nanotubes washed by strong acid through low-boiling alcohol solvent or water, the high-dispersion modified carbon nanotubes are obtained.

2. The high-dispersion carbon nanotube composite conductive ink according to claim 1, comprising the following components (with the weight percentages):

| | |
|---|---|
| 1) Modified carbon nanotube | 0.1-0.5%, |
| 2) The conductive polymeric material | 1%-4% |
| 3) Conductive polymer cosolvent | 0.3%-0.8% |
| 4) Solvent | 95%-97%. |

3. The high-dispersion carbon nanotube composite conductive ink according to claim 1, wherein the step (1) and/or step (2) are repeated once or twice.

4. The high-dispersion carbon nanotube composite conductive ink according to claim 1, wherein the low-boiling alcohol is ethanol or methanol.

5. The high-dispersion carbon nanotube composite conductive ink according to claim 1, wherein the strong oxidizing acid is trifluoroacetic acid, nitric acid, concentrated sulfuric acid, or nitric acid or concentrated sulfuric acid added with peroxide.

6. The high-dispersion carbon nanotube composite conductive ink according to claim 5, wherein the peroxide is ammonium peroxide or hydrogen peroxide.

7. The high-dispersion carbon nanotube composite conductive ink according to claim 1, wherein the carbon nanotube is a single-walled carbon nanotube, double-walled carbon nanotube, multi-walled carbon nanotube.

8. The high-dispersion carbon nanotube composite conductive ink according to claim 1, wherein the conductive polymer is one of polyaniline, 3,4-ethylene dioxythiophene, polyacetylene or polypyrrole or the combinations thereof.

9. The high-dispersion carbon nanotube composite conductive ink according to claim 1, wherein co-solvent for the conductive polymer is polystyrene sulfonate, camphorsulfonic acid or naphthalene sulfonic acid.

10. The high-dispersion carbon nanotube composite conductive ink according to claim 1, wherein the solvent is one of water, ethanol, methanol or the combinations thereof.
